(19) United States
(12) Patent Application Publication
(10) Pub. No.: US 2014/0015755 A1
(43) Pub. Date: Jan. 16, 2014

(54) METHOD AND APPARATUS FOR HANDWRITING INPUT USING A TOUCHPAD

(71) Applicant: ELAN MICROELECTRONICS CORPORATION, Hsinchu (TW)

(72) Inventors: Wae-Jone HAO, Zhongli City (TW); Chung-Jung LIOU, Taichung City (TW); Shuang-Yu HSIEH, Xinpu Township (TW)

(73) Assignee: Elan Microelectronics Corporation, Hsinchu (TW)

(21) Appl. No.: 13/795,883

(22) Filed: Mar. 12, 2013

(30) Foreign Application Priority Data
Jul. 10, 2012 (TW) 101124814

(51) Int. Cl. G06F 3/041

(52) U.S. Cl. CPC G06F 3/0416
USPC 345/168; 345/173

(57) ABSTRACT

A handwriting input method and apparatus use a determining process to determine whether or not to enter a handwriting mode according to a first touch when the first touch is detected by a touchpad, define and mark a writing frame corresponding to the touchpad on a screen upon entrance into the handwriting mode, and in the handwriting mode, when the touchpad detects a second touch, use a ratio to calculate coordinates of the second touch to generate corresponding coordinates for the writing frame according to an initial location of the second touch.

### FIELD OF THE INVENTION

The present invention is related generally to a handwriting input method and apparatus and, more particularly, to a method and apparatus for handwriting input using a touchpad.

### BACKGROUND OF THE INVENTION

Performing handwriting on a touch screen is intuitional operation, in which it is not difficult for a user to determine starting and ending points of a handwriting stroke on the screen, so the stroke paths forming characters can be well arranged, and the selection of candidate characters will be accurate. However, when operating a non-touch screen by performing handwriting on an associated touchpad, it is relatively hard to predict where the strokes made on the touchpad will be reflected on the screen, and therefore the stroke paths forming characters tend to be chaotic, while the selection of candidate characters will be difficult. Additionally, in some cases, such as for a remote television set, where the screen is untouchable, it is impossible to perform handwriting on the screen directly.

FIG. 1 illustrates one application of an integrated input method. For performing handwriting, by pressing a key 14 of a touch device 10, strokes made by a user on a touchpad 12 will be displayed in an input zone 26 defined in a window 28. The conventional method is known to achieve stork transmission using relative coordinates, wherein a trace displayed in the screen 30 takes the location of the cursor 38 as its starting point and then exhibits the relative displacement of the finger on the touchpad 12. However, this conventional method would have the problem about trace confusion. For example, when a user makes separate traces Tr1 and Tr2 by continuously conducting first and second touches on the touchpad 12, the resulting traces Tr3 and Tr4 shown in the screen 30 are nevertheless connected. The only way to make the trace Tr4 be presented correctly is releasing the key 14 after the completion of the trace Tr1, moving the cursor 38 to the expected input location, pressing the key 14 again, and then making the trace Tr2. In other words, handwriting input on the touchpad 12 requires repeatedly relocating the cursor after each trace, and is quite inconvenient. This is because the conventional handwriting input method using relative coordinates but not directly projecting coordinates on the touchpad 12 on to the screen 30. Moreover, in the method illustrated in FIG. 1, the location and size of the input zone 26 are default of the handwriting input application and are not adjustable by the user, somehow causing inconvenience in use.

### SUMMARY OF THE INVENTION

An objective of the present invention is to provide a handwriting input method using a touchpad.

Another objective of the present invention is to provide a method for dynamically adjusting a writing frame in terms of size.

Yet another objective of the present invention is to provide a method for using absolute coordinates to display traces.

According to the present invention, a handwriting input method includes performing a determining process to determine whether or not to enter a handwriting mode according to a first touch when a touchpad detects the first touch, defining and marking a writing frame corresponding to the touchpad on a screen upon entrance into the handwriting mode, and in the handwriting mode, using a ratio to calculate coordinates of a second touch to generate corresponding coordinates for the writing frame when the touchpad detects the second touch.

According to the present invention, a handwriting input method includes entering a handwriting mode when it is continuously detected in a period of time that a switching key is pressed, defining and marking a writing frame corresponding to the touchpad on a screen upon entrance into the handwriting mode, and in the handwriting mode, when the touchpad detects a touch, according to an initial location of the touch, using a ratio to calculate coordinates of the touch to generate corresponding coordinates for the writing frame.

According to the present invention, a handwriting input apparatus includes a touch device having a touchpad, and a processor configured to perform a determining process to determine whether or not to enter a handwriting mode according to a first touch when the touchpad detects the first touch, define and mark a writing frame corresponding to the touchpad on a screen upon entrance into the handwriting mode, and in the handwriting mode, when the touchpad detects a second touch, according to an initial location of the second touch, use a ratio to calculate coordinates of the second touch into corresponding coordinates for the writing frame.

According to the present invention, a handwriting input apparatus includes a switching key, a touch device having a touchpad, and a processor configured to enter a handwriting mode when it is continuously detected in a period of time that the switching key is pressed, define and mark a writing frame corresponding to the touchpad on a screen upon entrance into the handwriting mode, and in the handwriting mode, when the touchpad detects a touch, according to an initial location of the touch, use a ratio to calculate coordinates of the touch into corresponding coordinates for the writing frame.

In one embodiment, the writing frame is automatically adjusted in terms of location and size corresponding to an input zone of a specific application.

Preferably, the touchpad is defined with an adjustment zone, and any trace falling within the adjustment zone is used to scale up or down the writing frame.

The present invention is advantageous for dynamically adjusting the size of the writing frame, and is particularly beneficial as it prevents trace confusion by using absolute coordinates to project traces made in the writing zone of the touchpad directly onto the writing frame in the screen.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 illustrates a conventional handwriting input method using a touchpad;

FIG. 2 depicts one embodiment of switching a handwriting mode according to the present invention;

FIG. 3 depicts one embodiment of adjusting a writing frame in terms of size according to the present invention;

FIG. 4 shows how the present invention uses absolute coordinates to reflect a handwriting trace in a screen;

FIG. 5 is an alternative embodiment;

FIG. 6 is a schematic system structure according to the present invention;

FIG. 7 illustrates operational gestures according to the present invention;

FIG. 8 provides an embodiment where a physical key is used to switch the handwriting mode; and

FIG. 9 provides an embodiment where a predetermined gesture is used to switch the handwriting mode.

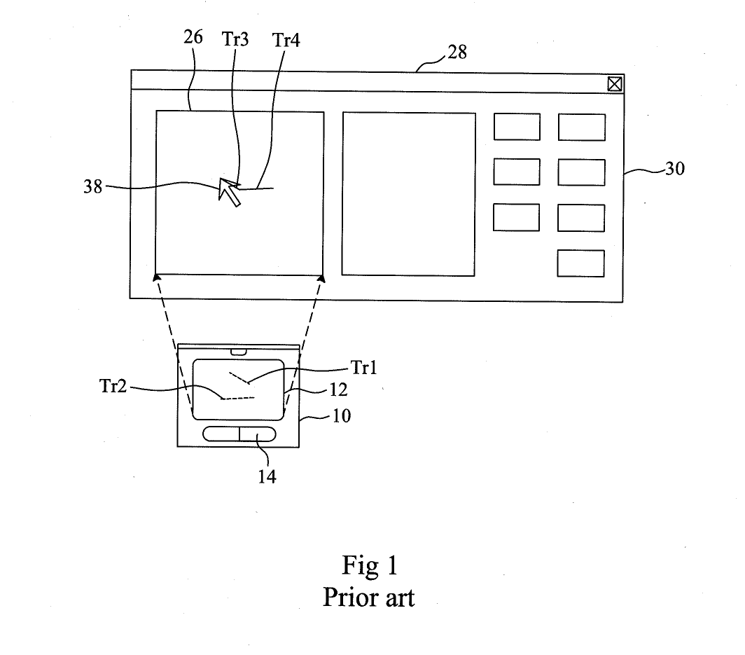

### DETAILED DESCRIPTION OF THE INVENTION

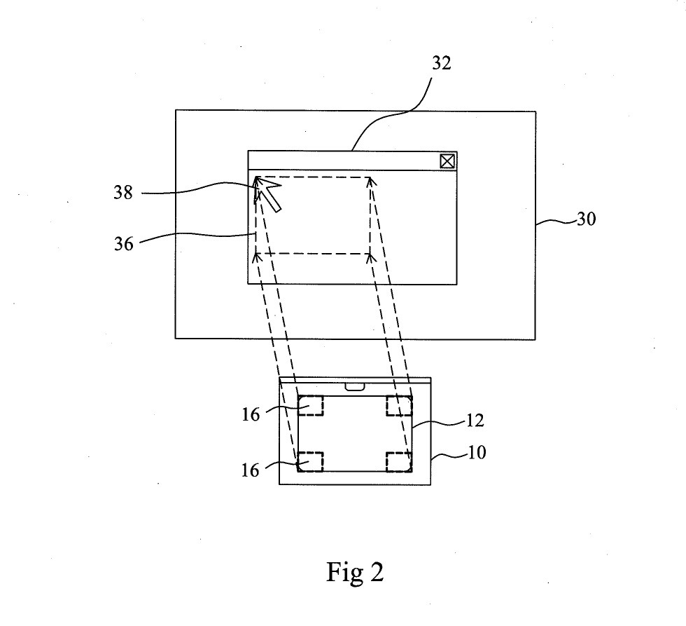

FIG. 2 through FIG. 4 illustrate a first embodiment according to the present invention, in which a touch device 10 generates a touch information by detecting a touch made by a user on a touchpad 12, and accordingly generates a signal for a driver in the associated operating system (OS) to perform input or other operation. The touch information includes coordinates of the starting point of the touch and coordinates of the moving trace. FIG. 2 illustrates switching of a handwriting mode. In the touchpad 12, switch zones 16 are defined, for example, at four corners of the touchpad 12. When the touchpad 12 detects that an initial location of a first touch is within any of the switch zone 16, the handwriting mode is started. At this time, the location of a cursor 38 in the screen 30 is taken as the benchmark for defining and marking a writing frame 36. As long as the first touch remains on the touchpad 12, the writing frame 36 stays in the screen 30, and the handwriting mode is maintained. If the touchpad 12 detects a touch, but the initial location of the touch is not within any of the switch zones 16, it will not enter the handwriting mode.

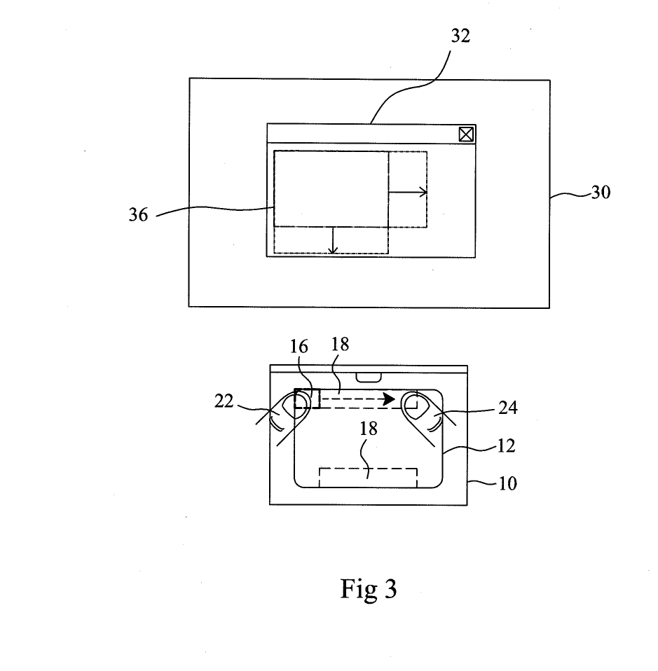

FIG. 3 illustrates size adjustment of the writing frame 36. In addition to the switch zones 16, the touchpad 12 is also defined with adjustment zones 18 at, for example, the upper and lower edges of the touchpad 12. One of the adjustment zones 18 is immediately next to the switch zones 16. In the handwriting mode, when the touch device 10 detects a touch made by a finger 24 on the touchpad 12, it determines whether or not to use a ratio to perform calculation to generate corresponding coordinates for the writing frame 26 according to the initial location of the touch of the finger 24. When a determining process determines that the initial location of the touch of the finger 24 is within the adjustment zone 18, the writing frame 36 is adjusted in terms of size according to the trace of the finger 24 moving on touchpad 12. For example, responsive to a trace of the finger 24 going away from another finger 22 or the switch zone 16, as indicated by the arrow in FIG. 3, the writing frame 36 is scaled up. On the contrary, as a result of the finger 24 moving toward the finger 22 or the switch zone 16, the writing frame 36 is scaled down. If the detection confirms that the finger 24 stays on the touchpad 12, the writing frame 36 is continuously adjusted according to the trace of the finger 24. In this embodiment, the user may use different adjustment zones 18 to adjust the length or width of the writing frame 36. For example, the upper adjustment zone 18 may be used to adjust the length of the writing frame 36, while the lower adjustment zone 18 is for adjusting the width of the writing frame 36, so that the aspect ratio of the writing frame 36 can be modified according to practical needs. In other embodiments, there is only one adjustment zone 18, so that when the trace of the finger 24 reflects it moving away from the finger 22 or the switch zone 16, both the length and width of the writing frame 36 are enlarged synchronously, and when the trace of the finger 24 reflects it approaching the finger 22 or the switch zone 16, both the length and width of the writing frame 36 are reduced synchronously.

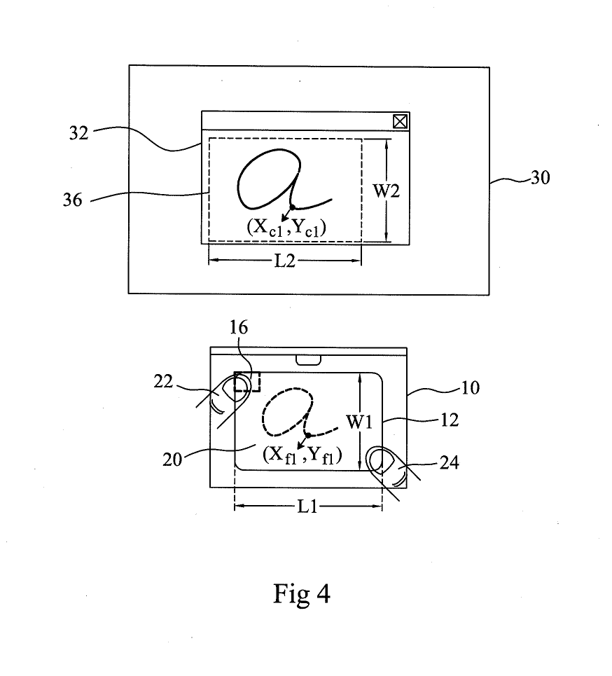

In the handwriting mode, if the initial location of a touch of the finger 24 is determined as out of the adjustment zone 18, as shown in FIG. 4, the whole touchpad 12 is redefined as a writing zone 20, and the coordinates of the moving trace of the finger 24 are shown in the writing frame 36. Preferably, no matter the finger 24 is within the adjustment zone or not, after the finger 24 leaves, if the touchpad 12 detects another touch, the touchpad 12 is redefined or entirely remains to be the writing zone 20. Each of coordinates along the moving trace of the finger 24 is calculated using a predetermined ratio to be converted into a set of corresponding coordinates in the writing frame 36, so that the writing performed in the writing zone 20 is just like performed in the writing frame 36. Every touch trace made in the writing zone 20 will be shown in a corresponding location simultaneously in the writing frame 36. For example, in FIG. 4, the touch trace “a” made in the writing zone 20 is projected onto a corresponding site in the writing frame 36 and shown as a letter “a”. The ratio is the aspect ratio between L2/L1 and W2/W1 of the touchpad 12 and the writing frame 36. Assuming that the coordinate set of the finger 24 on the touchpad 12 is (X_{f1}, Y_{f1}), according to the aspect ratios L2/L1 and W2/W1, the corresponding coordinate set in the writing frame 36 is (X_{c1}, Y_{c1}), wherein X_{c1}=X_{f1}×(L2/L1) and Y_{c1}=Y_{f1}×(W2/W1). This is established upon the principle of absolute coordinates. As compared to the relative coordinate system currently used in the art, the present invention is effective in decreasing trace confusion during handwriting input. In some other embodiments, the ratio may be alternatively a ratio between the aspect ratios of the touchpad 12 and the screen 30.

In one embodiment, it is unnecessary to have the finger 22 keeping pressing the switch zone 16. Instead, after the touch device 10 detects the first touch, and then detects the finger 24 again or another touch within a predetermined period of time, the handwriting mode is remained regardless the location of the finger 24 or the touch.

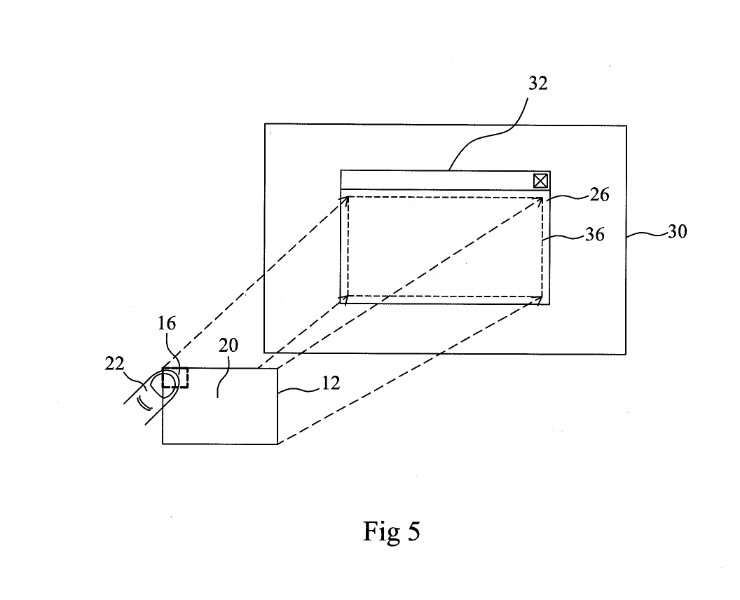

FIG. 5 provides an alternative embodiment. When it is determined through the touchpad 12 that the initial location of the finger 22 is in the switch zone 16, it will enter the handwriting mode and detect some specific applications running in the operating system, such as the handwriting input interface and integrated input panel for tablet computers provided by Windows. Then the writing frame 36 is automatically adjusted and adaptive to the input zone 26 of the specific application in terms of location and size. As long as the finger 22 keeps staying on the touchpad 12, the handwriting mode is maintained, and the writing frame 36 is remained in the screen 30. In the handwriting mode, the entire touchpad 12 is the writing zone 20, and each touch, whose initial location is within the writing zone 20, will have the coordinates along its moving trace simultaneously displayed in the writing frame 36, so that the activities made in the writing zone 20 are projected onto the writing frame 36 in an absolute-coordinate manner.

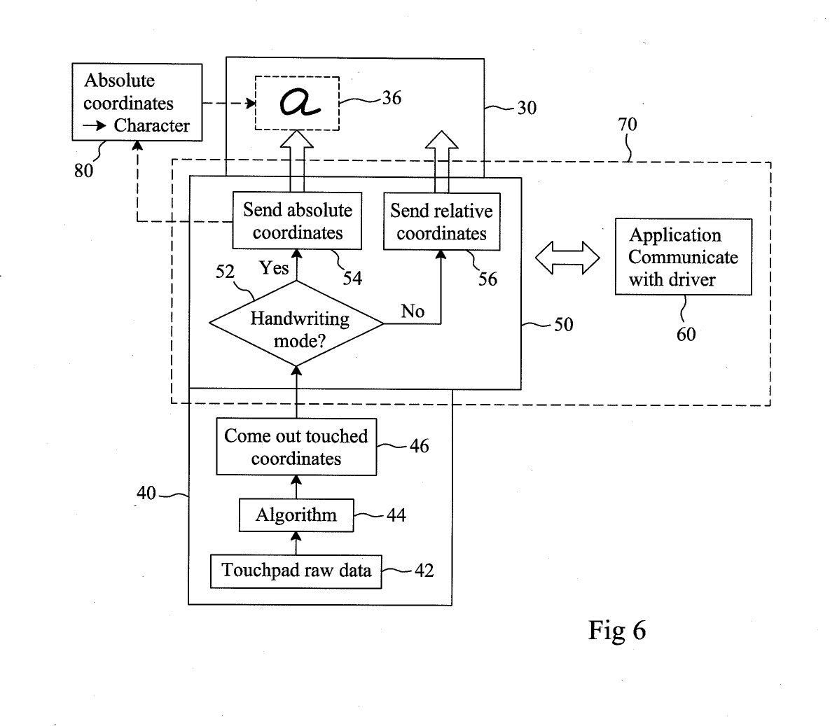

FIG. 6 depicts a system structure according to the present invention. In a process performed by a firmware 40 of the touchpad 12, step 42 is for the touchpad 12 to detect the touch on the touchpad 12 to generate touchpad raw data, and then, through step 44 which performs an algorithm to calculate the touched coordinates from the touchpad raw data, step 46 sends the touched coordinates to a driver 50 in the processor 70. In step 52, the driver 50 identifies whether or not it is for the handwriting mode according to the touched coordinates and the coordinate area information provided by an application 60, and if yes, then step 54 sends absolute coordinates for projecting the touch onto the writing frame 36, otherwise step 56 sends relative coordinates to the screen 30 for the latter to show the cursor's operation such as clicking, moving or others. The application 60 communicates with the driver 50 to display, hide or scale up/down the writing frame, or automatically adapt the writing frame 36 in terms of location and size. Preferably, the system includes a handwriting recognition module 80 for converting the absolute coordinates into characters and displaying the coordinates in the writing frame 36.

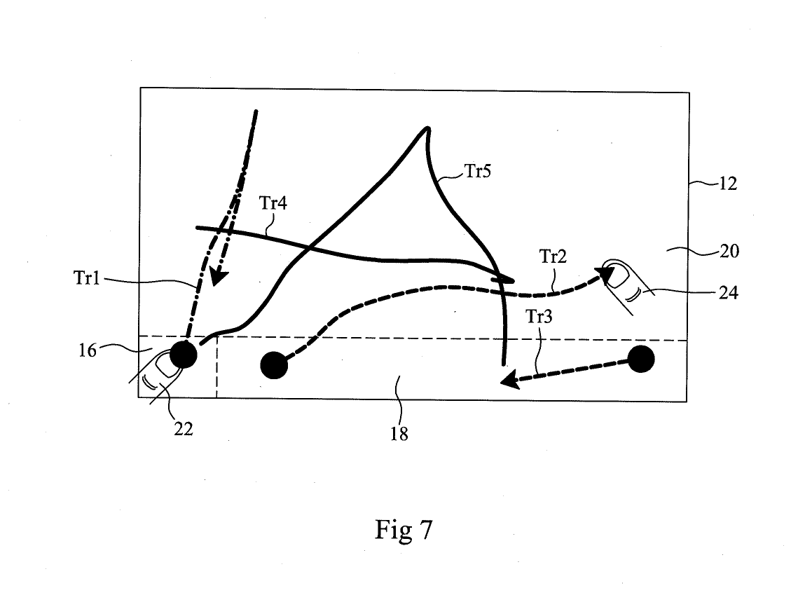

FIG. 7 illustrates operational gestures. In one application, the touchpad 12 is defined with three areas, including a switch zone 16 located at one corner of the touchpad 12, an adjustment zone 18 located at the lower edge of the touchpad 12 and adjacent to the switch zone 16, and a writing zone 20 immediately next to the switch zone 16 and the adjustment zone 18. When the driver 50 detects that the initial coordinate set of the finger 22 is within the switch zone 16 of the touchpad 12, it informs the application of the entrance of the handwriting mode, and shows the writing frame 36. As long as the finger 22 remains on the touchpad 12, even if its touch is out of the switch zone 16, as depicted by the trace Tr1, the handwriting mode is maintained and the driver 50 will keep informing the application of the coordinates of the touch. Once the touch disappears, the driver 50 ends the handwriting mode and informs the application of this, so the application cancels the writing frame 36 accordingly. In the handwriting mode, when detecting that there is a finger 24 appearing on the touchpad 12 with its initial coordinates within the adjustment zone 18 of the touchpad 12, the driver directs the application to scale up or down the writing frame. As long as the finger 24 is detected as staying on the touchpad 12, even if its touch is out of the adjustment zone 18, as depicted by the trace Tr2, the driver 50 will keep informing the application of the coordinates of the touch, for the application to scale up or down the writing frame 36. Scaling up/down the writing frame 36 may be performed in many ways. In one instance, when the finger 24 moves toward the switch zone 16, as depicted by the trace Tr3, the writing frame 36 is scaled down, and when the finger 24 leaves from the switch zone 16, the writing frame 36 is scaled up. Once the finger 24 disappears on the touchpad 12, the driver 50 directs the application to stop adjusting the writing frame 36. In the handwriting mode, when the driver 50 detects that there is a finger 24 on the touchpad 12 with its initial coordinates within the writing zone 20 of the touchpad 12, as depicted by the trace Tr4, the driver 50 transmits the absolute coordinates of the writing zone 20 corresponding to the writing frame 36 to the OS, even if the initial coordinate set of the finger 24 is within the switch zone 16 of the touchpad 12, or the trace is unintentionally moved to the adjustment zone 18 of the touchpad 12, as depicted by the trace Tr5, the driver 50 will transmit the absolute coordinates of the writing zone 20 corresponding to the writing frame 36 to the operating system.

According to the present invention, a determining process is carried out to determine whether or not to enter the handwriting mode. There are many ways to realize this determining process. In the above embodiments, the condition for switching the handwriting mode is that whether or not the initial location of the finger touch is in the switch zone 16. In other embodiments, alternative approaches may be used to fulfill the same purpose.

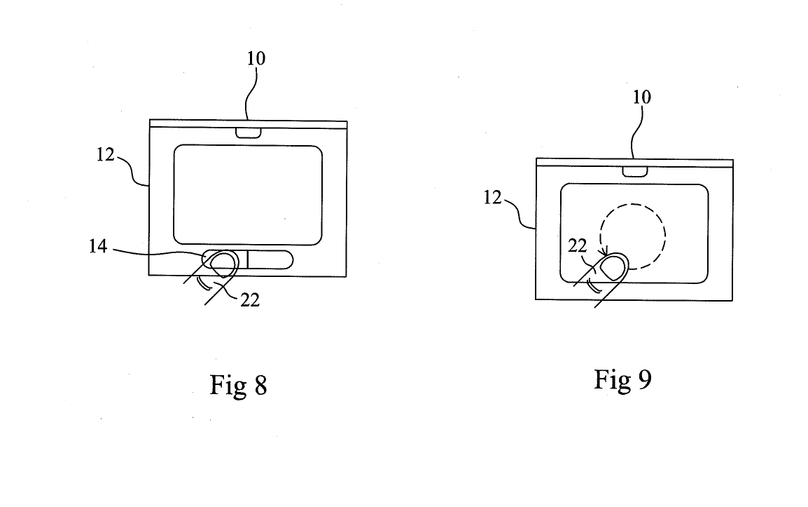

FIG. 8 illustrates using a physical key as the switch of the handwriting mode in the determining process. If in a period of time it is continuously detected that the switching key 14 of the touch device 10 is pressed by a finger 22, it will enter the handwriting mode. In one embodiment, the switching key 14 may be any key on a normal keyboard, such as CTRL. Preferably, after the period of time, the switching key 14 is continuously monitored to see whether it is released, and the handwriting mode is maintained until the switching key 14 is released. Likewise in the embodiment shown in FIG. 3, in the handwriting mode, when the touchpad 12 detects that a finger 24 is touching, it determines, according to the initial location of the finger 24 touch, whether or not coordinates of the moving trace of the finger 24 is calculated using a predetermined ratio to generate corresponding coordinates in the writing frame 36. When the determining process determines that the initial location of the touch of the finger 24 is in the adjustment zone 18, the size of the writing frame 36 is adjusted according to the moving trace of the finger 24. For example, when the finger 24 moves away from a predetermined set of coordinates, the writing frame 36 is enlarged in at least one of its length and width, and when the finger 24 moves toward the predetermined coordinates, the writing frame 36 is reduced in at least one of its length and width. Alternatively, as the embodiment shown in FIG. 5, after entrance of the handwriting mode, the writing frame 36 is automatically adjusted in terms of location and size according to the input zone of the running application. As the embodiment shown in FIG. 4, in the handwriting mode, if the initial location of the touch of the finger 24 is out of the adjustment zone 18, each set of coordinates along the moving trace of the finger 24 is calculated using a ratio to generate corresponding coordinates in the writing frame 36, so that the touch trace “a” made in the writing zone 20 will be projected onto the corresponding site in the writing frame 36 and displayed as the letter “a”.

FIG. 9 illustrates the determining process for determine whether or not to enter the handwriting mode according to a predetermined gesture. A touch of a finger 22 performed on the touchpad 12 of the touch device 10 is first detected determined whether it meets the conditions of a predetermined gesture or not. In an embodiment where the predetermined gesture is circling, when it is detected that the trace of the finger 22 is a circle, it will enter the handwriting mode. As the operation in the handwriting mode has been described in the above embodiments as shown in FIG. 3 through FIG. 5, no repeat will be given herein.

As known to people skilled in the art, the zones of the touchpad may be default or may be determined by a user through one or more applications.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A handwriting input method comprising:
A.) performing a determining process to determine whether or not to enter a handwriting mode according to a first touch when the first touch is detected by a touchpad;
B.) defining and marking a writing frame corresponding to the touchpad on a screen upon entrance into the handwriting mode; and
C.) in the handwriting mode, when the touchpad detects a second touch, according to an initial location of the second touch, using a ratio to calculate coordinates of the second touch to generate corresponding coordinates for the writing frame.

2. The handwriting input method of claim 1, wherein the determining process comprises identifying whether or not the first touch corresponds with a predetermined gesture, and if so, entering the handwriting mode.

3. The handwriting input method of claim 1, wherein the determining process comprises identifying whether or not an initial location of the first touch is within a switch zone on the touchpad, and if so, entering the handwriting mode.

4. The handwriting input method of claim 3, further comprising maintaining the handwriting mode until the first touch disappears.

5. The handwriting input method of claim 1, wherein the determining process comprises:
identifying whether or not an initial location of the first touch is within a switch zone on the touchpad; and
if the initial location of the first touch is within the switch zone and another touch is detected within a predetermined period of time after the first touch disappears, maintaining the handwriting mode.

6. The handwriting input method of claim 1, further comprising automatically adapting the writing frame in terms of location and size to an input zone of a specific application.

7. The handwriting input method of claim 1, further comprising identifying whether or not an initial location of the second touch is within an adjustment zone of the touchpad according to a second determining process, and if so, adjusting the writing frame according to a trace of the second touch.

8. The handwriting input method of claim 7, wherein if the second determining process determines that the initial location of the second touch is out of the adjustment zone of the touchpad, using the ratio to calculate coordinates of the second touch to generate corresponding coordinates for the writing frame.

9. The handwriting input method of claim 1, further comprising since a third touch has been detected in the handwriting mode, using the ratio to calculate coordinates of each touch to generate corresponding coordinates for the writing frame.

10. The handwriting input method of claim 7, wherein the step of adjusting the writing frame according to the trace of the second touch comprising:
decreasing at least one of a length and a width of the writing frame when the second touch approaches the first touch; and
increasing at least one of the length and the width of the writing frame when the second touch moves away from the first touch.

11. The handwriting input method of claim 7, wherein the adjustment zone is immediately next to a switch zone of the touchpad for enter the handwriting mode.

12. The handwriting input method of claim 7, further comprising:
if the initial location of the second touch is within the adjustment zone, keeping monitoring whether the second touch disappears; and
keeping adjusting the writing frame until the second touch disappears.

13. The handwriting input method of claim 1, wherein the step C comprises converting the corresponding coordinates for the writing frame into characters and displaying the characters in the writing frame.

14. The handwriting input method of claim 1, further comprising determining the ratio according to an aspect ratio of the touchpad with respect to an aspect ratio of the writing frame or of the screen.

15. A handwriting input method comprising:
A.) entering a handwriting mode when it is continuously detected in a period of time that a switching key is pressed;
B.) defining and marking a writing frame corresponding to the touchpad on a screen upon entrance into the handwriting mode; and
C.) in the handwriting mode, when the touchpad detects a touch, according to an initial location of the touch, using a ratio to calculate coordinates of the touch to generate corresponding coordinates for the writing frame.

16. The handwriting input method of claim 15, further comprising:
after entrance into the handwriting mode, detecting whether or not the switching key is released; and
maintaining the handwriting mode until the switching key is released.

17. The handwriting input method of claim 15, further comprising automatically adapting the writing frame in terms of location and size to an input zone of a specific application.

18. The handwriting input method of claim 15, further comprising using a determining process to determine whether or not the initial location of the touch is within the adjustment zone of the touchpad, and if so, adjusting the writing frame according to a trace of the touch.

19. The handwriting input method of claim 18, wherein if the determining process determines that the initial location of the touch is out of the adjustment zone of the touchpad, coordinates of the touch are calculated using the ratio to generate coordinates for the writing frame.

20. The handwriting input method of claim 15, further comprising since a second touch has been detected in the handwriting mode, using the ratio to calculate coordinates of each touch to generate corresponding coordinates for the writing frame.

21. The handwriting input method of claim 18, wherein the step of adjusting the writing frame according to the trace of the touch comprises:
decreasing at least one of a length and a width of the writing frame when the touch approaches a predetermined set of coordinates; and
increasing at least one of the length and the width of the writing frame when the touch moves away from the predetermined set of coordinates.

22. The handwriting input method of claim 18, further comprising:
if the initial location of the touch is within the adjustment zone of the touchpad, keeping monitoring whether or not the touch disappears; and
keeping adjusting the writing frame until the touch disappears.

23. The handwriting input method of claim 15, wherein the step C comprises converting the corresponding coordinates for the writing frame into characters and displaying the characters in the writing frame.

24. The handwriting input method of claim 15, further comprising determining the ratio according to an aspect ratio of the touchpad with respect to an aspect ratio of the writing frame or the screen.

25. A handwriting input apparatus comprising:
a touch device having a touchpad; and
a processor connected to the touchpad, configured to perform a determining process to determine whether or not to enter a handwriting mode according to a first touch when the touchpad detects the first touch, define and mark a writing frame corresponding to the touchpad on a screen upon entrance into the handwriting mode, and in the handwriting mode, when the touchpad detects a second touch, according to an initial location of the second touch, use a ratio to calculate coordinates of the second touch to generate corresponding coordinates for the writing frame.

26. The handwriting input apparatus of claim 25, further comprising a handwriting recognition module connected to the processor, operative to convert the corresponding coordinates for the writing frame into characters and displaying the characters in the writing frame.

27. The handwriting input apparatus of claim 25, wherein the touchpad has a switch zone located at a corner of the touchpad.

28. The handwriting input apparatus of claim 27, wherein the touchpad has an adjustment zone located at a side of the touchpad and immediately next to the switch zone.

29. The handwriting input apparatus of claim 28, wherein the touchpad has a writing zone immediately next to the switch zone and the adjustment zone.

30. The handwriting input apparatus of claim 28, wherein the ratio is determined by an aspect ratio of the touchpad with respect to an aspect ratio of the writing frame or of the screen.

31. A handwriting input apparatus comprising:
a switching key;
a touch device having a touchpad; and
a processor connected to the touchpad and the switching key, configured to enter a handwriting mode when it is continuously detected in a period of time that the switching key is pressed, define and mark a writing frame corresponding to the touchpad on a screen upon entrance into the handwriting mode, and in the handwriting mode, when the touchpad detects a touch, according to an initial location of the touch, use a ratio to calculate coordinates of the touch to generate corresponding coordinates for the writing frame.

32. The handwriting input apparatus of claim 31, further comprising a handwriting recognition module connected to the processor, operative to convert the corresponding coordinates for the writing frame into characters and displaying the characters in the writing frame.

33. The handwriting input apparatus of claim 31, wherein the touchpad has an adjustment zone located at one side of the touchpad.

34. The handwriting input apparatus of claim 33, wherein the touchpad has a writing zone immediately next to the adjustment zone.

35. The handwriting input apparatus of claim 31, wherein the switching key is fixedly installed on a keyboard or on the touch device.

36. The handwriting input apparatus of claim 31, wherein the ratio is determined by an aspect ratio of the touchpad with respect to an aspect ratio of the writing frame or of the screen.
